(19) United States
(12) Patent Application Publication
(10) Pub. No.: US 2026/0264886 A1
(43) Pub. Date: Sep. 10, 2026

(54) KINETIC CAPTURE OF ORBITAL DEBRIS

(71) Applicant: Blue Origin Manufacturing, LLC, Huntsville, AL (US)

(72) Inventor: Jonathan Agnew, Merritt Island, FL (US)

(21) Appl. No.: 19/075,660

(22) Filed: Mar. 10, 2025

(51) Int. Cl. B64G 1/10

(52) U.S. Cl. CPC B64G 1/1081

(57) ABSTRACT

Systems, devices, and methods for kinetically capturing orbital debris. The system actively seeks and captures debris in orbit and serves as a payload adaptor. The system releasably supports the payload on a rocket. The system releases the payload and then separates from the rocket and inserts into a debris collision orbit. The system may include thrusters and a flight control system. The system includes an impact structure that deforms upon impact and retains therein the debris. The system can capture small debris, such as 1 cm in width or less. The impact structure may be formed of a metal foam composite, such as an open-cell metal foam sandwiched by metallic layers. The system may be included in a launch vehicle system having multiple stages.

### BACKGROUND

### Field

The technology relates generally to orbital debris, and more specifically to systems and methods for kinetic capture of orbital debris.

### Description

Orbital debris includes used or spent rockets, spacecraft, or their components that are still in orbit after completion of a space mission. However, this small debris still poses significant risk to space-based assets. Such debris poses risks of damage to space missions by impact with even small objects at high velocities. Proposals to capture orbital debris include using nets, harpoons, or robotic arms. These are complex and expensive capture systems requiring precision for successful capture of small debris. Some small debris cannot be effectively and reliably removed in orbit by existing means (e.g., robot arms). Further, launching payloads for orbital debris capture into orbit (e.g., low earth orbit) on rockets designed to only launch that payload requires great cost and time for a single mission. Therefore, there exists a need for improvements to these and other drawbacks of existing systems and methods for capturing orbital debris.

### SUMMARY

Each of the embodiments disclosed herein has several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing approaches to capturing orbital debris.

Systems and methods are disclosed for kinetic capture of orbital debris. The system may target and actively capture orbital debris. “Kinetic” refers to active seeking and capturing of debris, as opposed to non-kinetic or passive capture, such as debris that just happens to strike and embed into an orbital debris shield of a spacecraft. The system according to the present disclosure may travel along an identified orbital path to seek out and capture the debris. The system may deploy from a rocket or spacecraft. The rocket or spacecraft may have a different mission besides capturing orbital debris. The system may thus “piggyback” or be an add-on to another mission. The system may have thrusters and other components to maneuver to the debris. The system may serve a dual purpose, such as a payload adaptor on a rocket for releasably supporting a payload. After the payload is released, the system may release from the rocket and capture orbital debris. In some embodiments, the system may stay attached to the rocket or spacecraft, for example where the rocket or spacecraft steers the system to debris or onto a trajectory toward debris. The system may include an absorbable structure configured to impact orbital debris objects and to receive and retain the objects therein. The objects may be retained within the structure's wall or penetrate the wall for retention in an internal cavity. The structure may be a composite structure, such as a metal foam composite having a lightweight metal foam sandwiched between thin metallic plates. The system may include a base that releasably attaches to the rocket. The system may include attachments for releasably supporting a payload.

In one aspect, a rocket system comprises a rocket and a debris capture system releasably coupled with the rocket and with a payload. The debris capture system comprises a base and an impact structure coupled to the base. The impact structure comprises a metal foam composite configured to receive and retain therein orbital debris. The debris capture system is configured to be released from the rocket after the payload is released from the debris capture system.

Various embodiments of the above and other aspects may be implemented. The metal foam composite may comprise an open-cell metal foam sandwiched between metallic layers. The debris capture system may comprise a payload adaptor supporting the payload. The system may further comprise at least one release device that releasably couples the debris capture system with the rocket. The system may further comprise at least one release device that releasably couples the payload with the debris capture system. The debris capture system may comprise one or more thrusters. The debris capture system may comprise a flight control system.

In another aspect, an orbital debris capture system comprises an impact structure, a first release system, a second release system, and a flight control system. The impact structure is configured to deform upon impact with orbital debris and to retain the orbital debris after impact. The first release system is configured to releasably couple the orbital debris capture system with a payload. The second release system is configured to releasably couple the orbital debris capture system with a rocket. The flight control system is configured to insert the orbital debris capture system into a debris collision orbit after release from the rocket.

Various embodiments of the above and other aspects may be implemented. The impact structure may comprise a metal foam composite. The metal foam composite may comprise an open-cell metal foam sandwiched between metallic layers. The orbital debris capture system may further comprise a payload adaptor supporting the payload. The orbital debris capture system may further comprise one or more thrusters. The impact structure may comprise a sloped sidewall. The impact structure may be configured to capture orbital debris with a maximum width of 2 cm or less.

In another aspect, an orbital debris capture system comprises an impact structure and a control system. The impact structure is configured to deform upon impact with orbital debris and to retain the orbital debris after impact. The control system comprises one or more processors and one or more memories. The one or more memories have instructions stored thereon that, when executed by the one or more processors, causes the orbital debris capture system to perform a method of capturing orbital debris. The method comprises releasing a payload from the orbital debris capture system, releasing the orbital debris capture system from a rocket, and inserting the orbital debris capture system into a debris collision orbit.

Various embodiments of the above and other aspects may be implemented. The method may further comprise impacting the orbital debris with the impact structure. The method may further comprise deorbiting the orbital debris capture system. The method may further comprise firing thrusters of the orbital debris capture system. The method may further comprise adjusting an attitude of the orbital debris capture system. The impact structure may comprise a metal foam composite.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made without departing from the spirit or scope of the subject matter presented here. It will be readily understood that the aspects of the present disclosure, as generally described herein, and illustrated in the drawings, may be arranged, substituted, combined, and designed in a wide variety of different configurations, all of which are explicitly contemplated and make part of this disclosure.

FIG. 1A illustrates a side view of an embodiment of a launch vehicle having a debris capture system releasably coupled with a second stage and a payload.

FIG. 1B illustrates a side view of an embodiment of a second stage and debris capture system that may be used with the launch vehicle of FIG. 1A, and having release systems for releasably coupling the debris capture system with the second stage and the payload.

FIG. 2A illustrates a top view of an embodiment of the debris capture system of FIG. 1A shown in isolation.

FIG. 2B illustrates a cross-sectional view of an embodiment of the debris capture system of FIG. 2A as taken along the line 2B-2B of FIG. 2A.

FIG. 2C illustrates an embodiment of the debris capture system of FIG. 2B having a release system for releasably coupling a payload to the debris capture system.

FIG. 3A illustrates an embodiment of a debris capture system in orbit, separated from a second stage and targeting debris, and that may be used with the launch vehicle of FIG. 1A.

FIGS. 3B and 3C illustrate sequential views of an embodiment of the debris capture system of FIG. 2B shown moving toward and capturing orbital debris.

FIG. 4 illustrates an embodiment of the debris capture system of FIG. 2B having a flight control system.

FIGS. 5A-5C illustrate cross-sectional views of different embodiments of the debris capture system having different cross-sectional shapes.

FIGS. 6A-6D illustrate top views of different embodiments of the debris capture system having different shapes.

FIG. 7 illustrates a schematic of an embodiment of a debris capture system with a control system.

FIG. 8 illustrates a flow chart showing an embodiment of a method for capturing orbital debris that may be used with or performed by any of the debris capture systems of FIGS. 1A-7.

FIG. 9 illustrates a flow chart showing an embodiment of a method of manufacturing a debris capture system that may be used to make any of the debris capture systems of FIGS. 1A-7.

FIG. 10 illustrates a flow chart showing an embodiment of a method of assembling a debris capture system with a rocket and a payload and that may be used with any of the debris capture systems of FIGS. 1A-7.

### DETAILED DESCRIPTION

The following detailed description is directed to certain specific embodiments for devices, systems, and methods related to an orbital debris capture system. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the present disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Reference will now be made in detail to embodiments of the present disclosure, examples of which are illustrated in the accompanying drawings. Wherever possible, the same reference numbers will be used throughout the drawings to refer to the same or like parts, with the understanding that there may be different embodiments of the same part as shown and described herein.

The systems and methods according to the present disclosure kinetically capture and remove orbital debris from orbit (e.g., a low earth orbit, or other orbits). The systems may be used on rocket launches that also send a payload to orbit. The rocket includes a debris capture system with a release system that supports a payload. Once the payload separates from the debris capture system, the debris capture system may separate from the rocket assembly so the debris capture system can maneuver toward and capture orbital debris. The debris capture system may therefore serve a dual purpose as a payload adaptor to support sand release the payload within a launch vehicle as well as a debris capture system. The debris capture system may include an impact structure, such as a metal foam composite, that may kinetically capture orbital debris without creating additional orbital debris. “Kinetic” refers to active seeking and capturing of debris, as opposed to non-kinetic or passive capture, such as debris that just happens to strike and embed into an orbital debris shield of a spacecraft. The debris capture system may include a flight control system that moves and/or orients the debris capture system into an orbit and/or orientation to capture orbital debris. The orbital debris system may be specially suited for capturing “small” debris components, as further described herein. A structural wall of the debris capture system, such as a metal foam composite structure, may deform upon impact with the debris to receive and retain the debris inside the structure. The debris capture system may deorbit after the debris capture system captures the orbital debris. The debris capture system may burn up in the atmosphere with the debris upon reentry. Example debris capture systems with these and other advantages are described herein with respect to example launch vehicle, rocket, and payload configurations. It is understood the debris capture system may be used with a variety of other launch vehicle, rocket, and payload configurations.

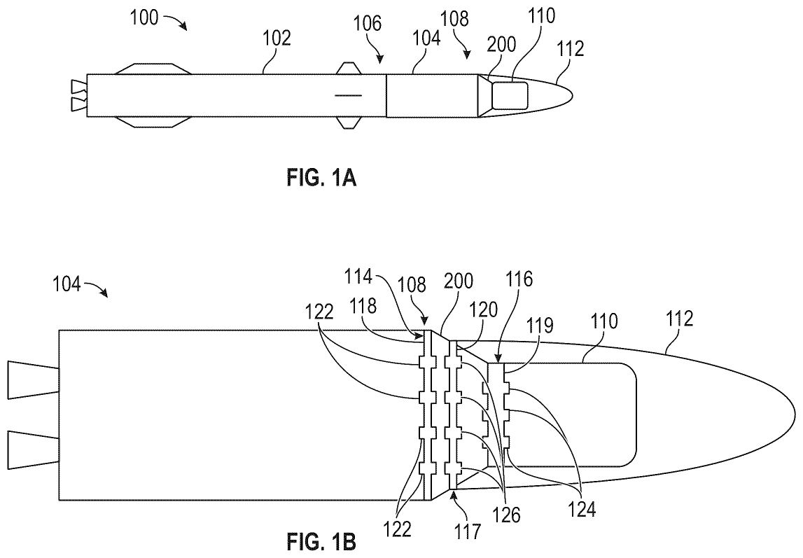

FIG. 1A illustrates a side view of an embodiment of a launch vehicle 100 that includes a debris capture system 200. The launch vehicle 100 may include a first stage 102 (e.g., a lower stage), a second stage 104 (e.g., an upper stage), and the debris capture system 200 attached to the second stage 104. The second stage 104 may be coupled to a forward end 106 of the first stage 102. The debris capture system 200 may be coupled to a forward end 108 of the second stage 104. The debris capture system 200 releasably supports a payload 110. A fairing 112 (shown transparently, for clarity) is releasably attached with the second stage 104.

During a launch, the first stage 102 is configured for atmospheric launch operation to send the launch vehicle 100 to the upper atmosphere or lower orbit. Once the launch vehicle 100 is in the upper atmosphere or lower orbit, the second stage 104 is configured to separate from the first stage 102 and deliver the payload 110 to a planned orbit. The first stage 102 may reenter the atmosphere and either burn up in the atmosphere, drop to the ground such as into the ocean, or land for reuse. The fairing 112 is configured to release from the second stage 104 to expose the payload 110 and debris capture system 200. The debris capture system 200 is configured to release (e.g., separate, decouple, etc.) the payload 110. The fairing 112 and/or payload 110 release may be performed after the second stage 104 reaches a desired altitude or orbit.

FIG. 1B illustrates a side view of an embodiment of the second stage 104, having an embodiment of the debris capture system 200, and that may be used with the launch vehicle 100 of FIG. 1A. As shown in FIG. 1B, the second stage 104 may include one or more release systems, such as a first release system 117, a second release system 116, and/or a third release system 114. There may be any combination of these release systems, and/or additional release systems.

The first release system 117 may be configured to couple the fairing 112 to the second stage 104, such as to the debris capture system 200 as shown, or to other components of the second stage 104, such as with the body of the rocket or with a fairing adaptor etc. “Couple” as used herein includes its usual and customary meaning and includes without limitation direct coupling together as well as indirect coupling such as with a bracket or other component between the two coupled objects. The first release system 117 may be configured to release the fairing 112 from the second stage 104. “Release” as used herein includes its usual and customary meaning and includes without limitation a passive separating of two components from each other such that they are free to move apart, as well as a more active separation where one or both objects are also biased and/or moved away from each other.

The first release system 117 may include the first adaptor 120 and/or one or more first release devices 126. The first adaptor 120 may be fixedly coupled with the second stage 104 such as to the debris capture system 200 as shown, or to other components of the second stage 104, such as with the body of the second stage rocket or with a fairing adaptor etc. The fairing 112 may be releasably coupled to the first adaptor 120 or other component. The fairing 112 may be positioned over all or some of the components at the forward end 108 of the second stage 104, for example the payload 110 and the debris capture system 200, in order to protect (e.g., prevent or inhibit damage to) the components. As shown, part of the debris capture system 200 may be exposed to the ambient atmosphere and include thermal protection in these exposed areas as needed. The fairing 112 may, in some embodiments, completely cover the debris capture system 200. For example, the fairing 112 may extend to the forward end of the body of the second stage 104. The first release devices 126 may be actuated to release the fairing 112 from the first adaptor 120 or other component. The fairing 112 may fall away from the second stage 104. The fairing 112 may include two or more portions that separate upon release from the first adaptor 120 or other component. There may be additional release devices that releasably couple the two or more portions of the fairing 112 together. The first release devices 126 or portions thereof may stay with the fairing 112 and/or the second stage 104 after separation of the fairing 112. Separation of the fairing 112 may expose the debris capture system 200 and the payload 110.

The second release system 116 may be configured to couple the payload 110 with the debris capture system 200. The second release system 116 may be configured to release the payload 110 from the debris capture system 200.

The second release system 116 may include the second adaptor 119 and/or one or more second release devices 124. The second adaptor 119 may be fixedly coupled to the debris capture system 200. The second adaptor 119 may be a separate component attached to the debris capture system 200. The second adaptor 119 may be formed by, or be an integral part of, the debris capture system 200. The debris capture system 200 may therefore serve dual purposes as a payload adaptor and as a debris capturing system. The second release devices 124 may releasably couple the payload 110 with the second adaptor 119. The second release devices 124 may be actuated to release the payload 110 from the second adaptor 119. The payload 110 may then separate from the second adaptor 119 and continue to its own trajectory. The payload 110 may be a spacecraft, satellite, etc. and may have thrusters or other propulsion components to self-propel to its own trajectory. After separation, the second release devices 124 or portions thereof may stay with the payload 110 and/or the second adaptor 119.

In some embodiments, the second adaptor 119 may be fixedly coupled with the payload 110 and releasably coupled with the debris capture system 200. This is another example of how the debris capture system 200 may serve the dual purposes of a payload adaptor and a debris capturing system. In such embodiments, the second release devices 124 may actuate to release the second adaptor 119 from the debris capture system 200, and the second adaptor 119 with the payload 110 may travel together away from the second stage 104. After separation, the second release devices 124 or portions thereof may stay with the debris capture system 200 and/or the second adaptor 119.

The third release system 114 may be configured to couple the debris capture system 200 with the second stage 104. The third release system 114 may be configured to release the debris capture system 200 from the second stage 104.

The third release system 114 may include a third adaptor 118 and/or one or more third release devices 122. Some or all of the first, second, and third release devices 122, 124, 126 may be the same or similar type of release devices, or some or all of them may be different types of release devices. Some or all of the first, second, and third release devices 122, 124, 126 may be hold down and release mechanisms (HDRM), pyrotechnic devices, electrically-initiated devices, mechanical devices, or other type devices.

The debris capture system 200 may be fixedly coupled to the third adaptor 118, and the third release devices 122 may releasably couple the third adaptor 118 with the second stage 104 (such as a body portion of the second stage rocket). The third release devices 122 may be actuated to release the third adaptor 118 from the second stage 104, allowing the third adaptor 118, with the debris capture system 200 attached thereto, to separate from the second stage 104. After release, the third release devices 122 or portions thereof may stay attached to the second stage 104 and/or to the third adaptor 118.

In some embodiments, the third adaptor 118 may be fixedly coupled to the second stage 104, and the release devices 122 may releasably couple the debris capture system 200 with the third adaptor 118. In such case, the release devices 122 may be actuated to release the debris capture system 200 from the third adaptor 118, allowing the debris capture system 200 to separate from the third adaptor 118, such that the third adaptor 118 stays coupled with the second stage 104. In such embodiments, the third release devices 122 or portions thereof may stay attached to the debris capture system 200 and/or to the third adaptor 118.

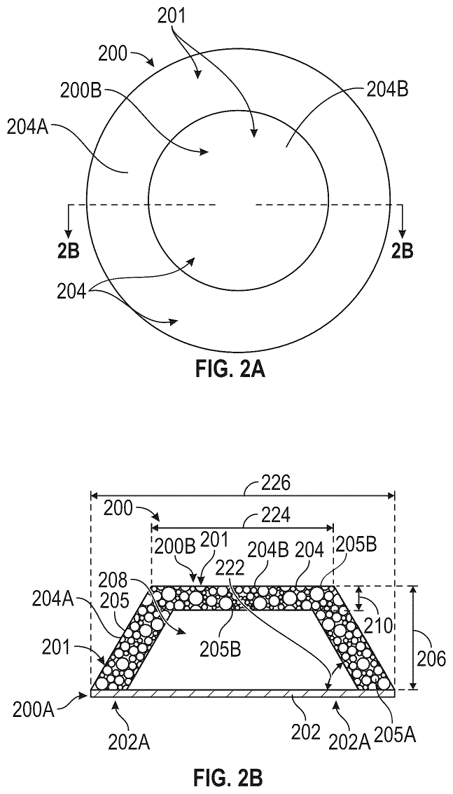

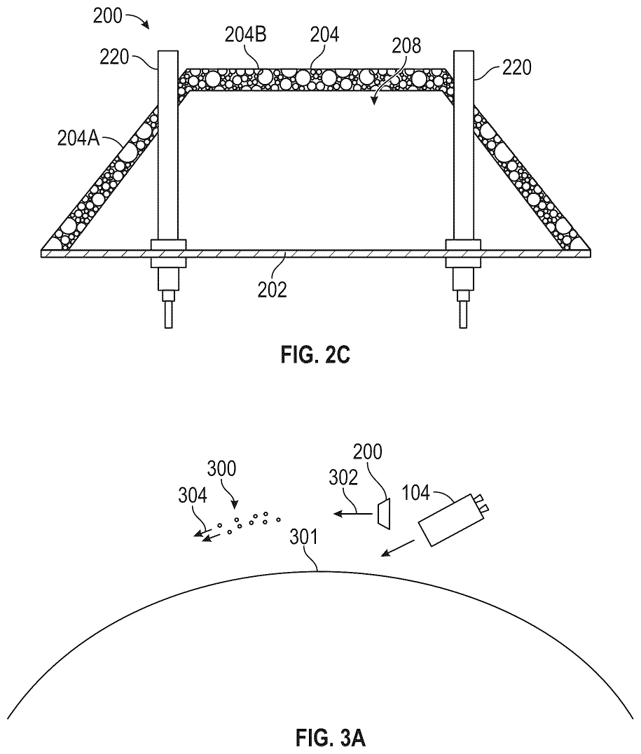

FIGS. 2A-4 illustrate various embodiments of the debris capture system 200 that may be used with the launch vehicle 100 or the second stage 104. Any features of the debris capture system 200 shown in, or described with respect to, FIGS. 2A-4 may be included in any of the embodiments of the debris capture systems disclosed herein.

FIGS. 2A and 2B illustrate, respectively, a top view of an embodiment of the debris capture system 200 and a cross-sectional view of the debris capture system 200 of FIG. 2A, as taken along the line 2B-2B shown in FIG. 2A.

As shown in FIG. 2A, the debris capture system 200 may have an impact structure 204. The impact structure 204 may have a variety of shapes and sizes. The impact structure 204 may be sized and shaped to support the payload thereon during launch and to receive and retain orbital debris therein. The impact structure 204 may include a sidewall 204A and/or a forward wall 204B.

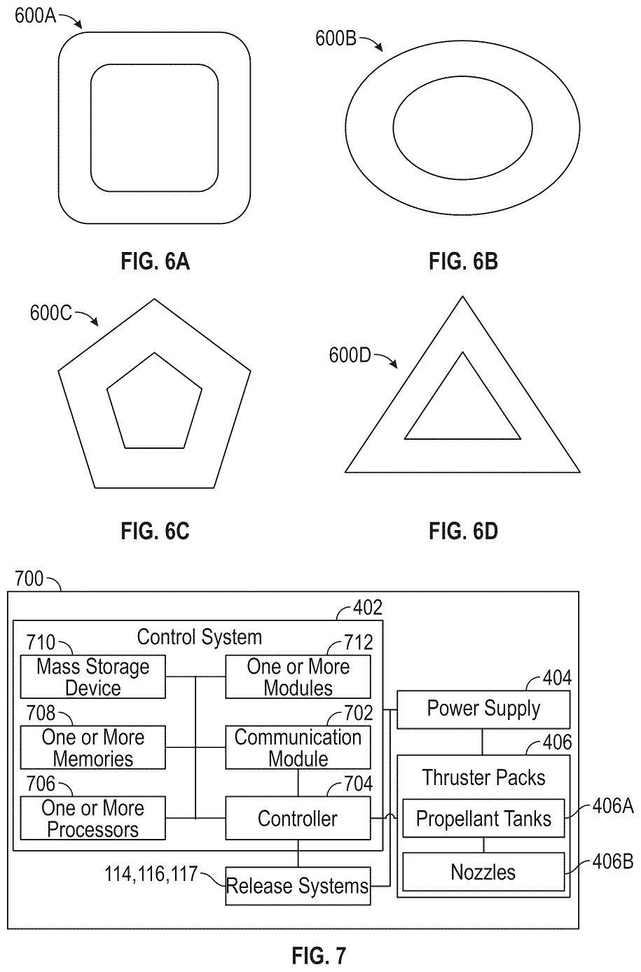

The sidewall 204A and/or forward wall 204B may have a rounded shape, such as a circular shape as shown. The sidewall 204A may form a ring or ring-like shape to serve as a ring adaptor for the payload. The sidewall 204A and/or forward wall 204B may have other rounded shapes, a polygonal shape, or various other shapes, such as those shown and described with respect to FIGS. 6A-6D. The sidewall 204A and the forward wall 204B may have the same or similar shape as each other, or they may each have different shapes. The sidewall 204A may extend circumferentially and support the forward wall 204B on a forward end of the sidewall 204A. The impact structure 204 may have a frustoconical shape and/or a trapezoidal cross-sectional profile, as more clearly shown in FIG. 2B.

As shown in FIG. 2B, the debris capture system 200 may include a forward structure 201 coupled with a base 202. The forward structure 201 may comprise the impact structure 204, and/or other components. The base 202 may include a carbon-based composite and/or any other suitable material. The base 202 may be aluminum, aluminum alloy, carbon composite, other suitable materials, or combinations thereof. As a structural element, the base 202 may provide or form a secure attachment to the material of the forward structure 201, permitting the debris capture system 200 to be coupled to the second stage 104 via bolts, band clamps, pyrotechnic fasteners, etc. The base 202 may also provide rigid attachment points for lifting/handling hardware. Overall, the base 202 may be an adapter between dissimilar materials to simplify handling and assembly.

The base 202 may be positioned at an aft end 200A of the debris capture system 200. The base 202 may be configured to couple the debris capture system 200 to a rocket, such as the second stage 104. The base 202 may be releasably coupled with the second stage 104 via the third release system 114. The impact structure 204 may be fixedly coupled to the base 202. The impact structure 204 may be coupled to an outer portion 202A located along an outer perimeter of a forward surface of the base 202.

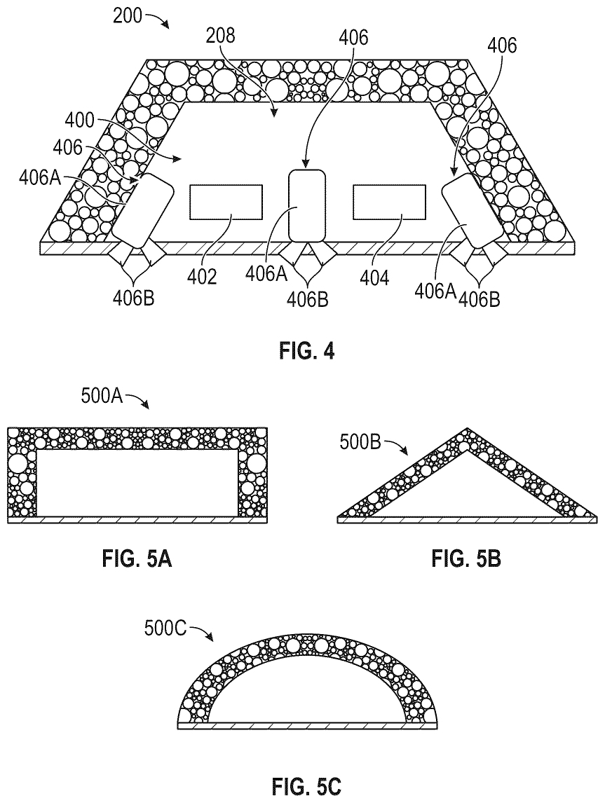

The base 202 and the impact structure 204 may form a cavity 208 located in between the base 202 and the impact structure 204. The cavity 208 may include space for various components for the release devices and/or flight control system of the debris capture system 200, for example as further described herein with respect to FIGS. 2C and 4.

The forward wall 204B may form the forward end 200B of the debris capture system 200. The forward wall 204B may be parallel with an aft end of the debris capture system 200. The sidewall 204A may be sloped to expose more surface area of the sidewall 204A to debris travelling toward the impact structure 204. The sidewall 204A may extend from the base 202 at an angle 222. The angle 222 may be from 25 to 85 degrees, from 35 to 75 degrees, or from 45 to 65 degrees.

A forward outer width 224 (e.g., an outer diameter, for circular shapes) of the forward wall 204B of the impact structure 204 may be smaller than an aft outer width 226 (e.g., outer diameter, for circular shapes) of the aft end 200A of the sidewall 204A and/or of the base 202. The forward outer width 224 may be from 500 mm to 2,250 mm, from 750 mm to 2,000 mm, or from 900 mm to 1,750 mm. The forward outer width 224 may have a length equal to or substantially equal to the diameter of a forward payload attachment interface. The payload attachment interface may be one of many industry standard interface sizes, such as 937 mm, 1194 mm or a 1666 mm diameter interface, which may be a circular ring section, and/or the Evolved Expendable Launch Vehicle (EELV) standard of 1575 mm (62 inch). In some embodiments, the forward outer width 224 may be equal to or greater than the aft outer width 226, resulting in a cylindrical or truncated conical “boattail” impactor structure. Such a configuration may be useful as an interstage component, as a coupler for a full-width payload, or as a transition to a larger diameter than the attached second stage.

In some embodiments, the forward wall 204B may take the form of an apex point or rounded dome, resulting in a cone-shaped impact structure. Such a configuration may be advantageous if mounted forward of a payload, or in a primary (sole-purpose) debris interception mission.

The aft outer width 226 may have a length equal to or substantially equal to a width of the host launch vehicle to which the debris capture system 200 is attached, such as the second stage 104. The aft outer width 226 may be from 4 to 10 meters, from 5 to 9 meters, from 6 to 8 meters, or 7 meters or about 7 meters. The aft outer width 226 may be slightly less than the width of the host launch vehicle for clearance, to permit overall encapsulation within the fairing 112. For example, the aft outer width 226 may be 6.5 meters for attachment to the second stage 104 having an outer width of 7 meters, encapsulated overall within the fairing 112 having an interior usable width of 6.75 meters.

In some embodiments, the aft outer width 226 may be greater than or equal to the width of an attachment point to a parent launch vehicle, which may be a small fraction of the overall width of the parent launch vehicle. This may be useful to permit an embodiment where multiple smaller capture vehicles are deployed and/or the capture vehicle is itself a secondary payload.

The impact structure 204 may have a height 206 extending axially from the base 202. The height 206 may be from one quarter to three-quarters of the aft outer width 226. The height 206 may be optimized to accommodate the geometry of the launch vehicle, to permit installation of instrumentation/propulsion equipment, and to ensure sufficient thickness of the impact surfaces.

The forward wall 204B may define a transverse thickness 210 in the axial direction. The sidewall 204A may have the same or similar thickness as the forward wall 204B, or a different thickness. In some embodiments, the thickness 210 of the forward wall 204B may be bounded by an anticipated mass/velocity distribution of debris particles to be intercepted on orbit. When the impact structure 204 is also a primary structural element, the thickness 210 may be bounded by the worst-case static and dynamic loads encountered during the launch phase, multiplied by some factor of safety. The transverse thickness 210 may thus be dependent on the material used in construction, anticipated launch-phase loads, and the duration desired from the debris interception phase of the mission. In some embodiments, the thickness 210 may be from 1 to 12 inches, from 2 to 10 inches, from 4 to 8 inches, or from 5 to 7 inches.

The impact structure 204 may include a metal foam composite 205. The metal foam composite may include a metal foam 205A sandwiched between two or more layers 205B, which may be dissimilar materials, on the outside and inside of the impact structure, and/or which may be metallic layers. The sidewall 204A and the forward wall 204B may include the metal foam composite 205.

The metal foam 205A may be a material including a solid metal with pores or voids between the solid metal. The empty spaces within the pores may comprise a majority of a volume of an envelope of the metal foam 205A. The metal foam 205A may be an open-cell metal foam having interconnected pores. In some embodiments, the pores may be sealed (e.g. closed-cell foam). The metal foam 205A may be sandwiched between layers which may be dissimilar materials, and in some embodiments one or more metallic layers, on opposing sides of the metal foam 205A. The metal foam 205A may have a high porosity. The metal may be only 5-25% of the total volume of the metal foam envelope 205A. The metal foam 205A may be an aluminum metal foam. Other metal foams may be used, such as titanium metal foam, steel metal foam, other metal foams, or alloys thereof.

Each layer of the layers 205B may have the same thickness as each other, or they may have different thicknesses. The thicknesses may be based on hypervelocity impact performance. The layers 205B may each have a thickness from 0.1 mil (0.0001 inches) to 1 inch, from 0.2 mils to 0.75 inches, from 0.3 mils to 0.625 inches, from 0.4 mils to 0.5 inches, from 0.5 mils to 0.325 inches, from 0.6 mils to 0.3 inches, from 0.7 mils to 0.25 inches, or from 0.9 mils to 0.25 inches.

One or more of the layers 205B may be thin sheets of metal or other materials. The layers of layers 205B may be metals, such as aluminum, titanium, steel, other metals or alloys thereof, or other suitable materials, or combinations thereof. The layers 205B may include voids or other empty spaces.

One or more of the layers 205B may not be metals. For example, high performing composite impact structures can be realized by replacing the metal layer with any one or more of the following: empty space (via standoff distance), ceramics, sapphire, natural or synthetic rubber, thermoplastics, polyethylene or other polymers generally, non-Newtonian fluids, ferrofluids, carbides, heterogenous mixtures, silicates, cements, or generally any material arrangement leading to significant, abrupt changes in density, elasticity, bulk modulus, or sound propagation velocity as a function of depth.

There may be a single layer of the layers 205B on each side of the metal foam. In some embodiments, there may be a plurality of layers, such as two, three, four, five, six seven, eight, or more, of the layers 205B on one or both sides of the metal foam.

FIG. 2C illustrates a cross-sectional view of another embodiment of the debris capture system 200 having multiple release devices 220. The payload 110 may be releasably coupled with the debris capture system 200 via the release devices 220. The release devices 220 may extend from a forward side of the impact structure 204, through the cavity 208, and to the base 202. In some embodiments, the release devices 220 may not extend into the cavity 208 and/or may not be coupled with the base 202. In some embodiments, the release devices 220 may be coupled with the sidewall 204A as shown, and/or with the forward wall 204B.

The release devices 220 may releasably support the payload 110 on ends of the release devices 220 located forward and/or outside of the impact structure 204. The release devices 220 may be configured to rotate and/or retract to release the payload 110 from the debris capture system 200. In some embodiments, the release devices 220 may releasably couple with the second adaptor 119 (which may be fixedly attached with the payload 110) and thereby release the second adaptor 119 with the payload 110, as described herein with respect to FIGS. 1A and 1B.

The release devices 220 may be positioned along an adaptor, such as a payload adaptor, for example as described with respect to FIG. 1B. The impact structure 204 or other features of the debris capture system 200 may serve as an adaptor to support the payload 110. Payload attachment may be achieved via an industry standard means of payload attachment, such as an Evolved Expendable Launch Vehicle (EELV) ring, an EELV Secondary Payload Adaptor (ESPA) ring, a national Security Space Launch (NSSL) pattern bolted ring, a clamp band ring, or a bolted flange.

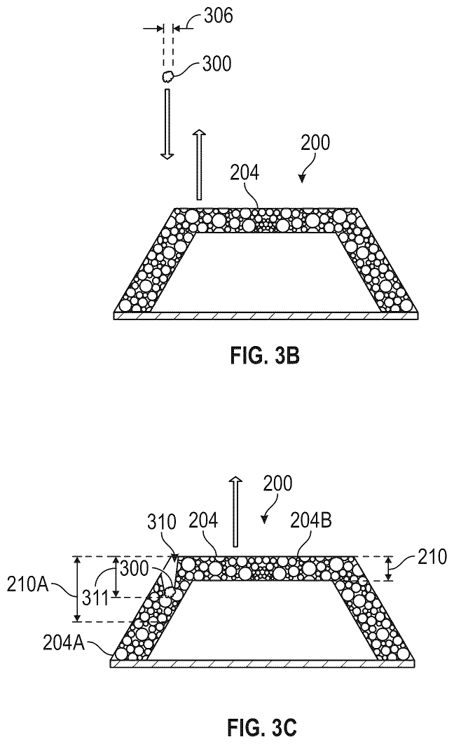

FIGS. 3A-3C illustrate various views of the debris capture system 200 targeting and capturing orbital debris 300 after release from the second stage 104. The payload 110 and fairing 112 may have already released from the debris capture system 200. The debris capture system 200 may travel along a debris collision orbit 302. In some embodiments, as described further with respect to FIG. 4, the debris capture system 200 may include a flight control system configured to maneuver and insert the debris capture system 200 into the debris collision orbit 302. In some embodiments, the second stage 104 may be positioned such that when the debris capture system 200 releases from the second stage 104, the debris capture system 200 is in or near the debris collision orbit 302.

In some embodiments, orbital debris 300 may travel along a debris orbit 304 around Earth 301. The debris collision orbit 302 and the debris orbit 304 may be in the same direction. In some embodiments, the debris capture system 200 may travel along the debris collision orbit 302 in a direction opposite that of the debris orbit 304. The debris capture system 200 may travel at a different relative speed than the orbital debris 300 (e.g., faster or slower).

The debris collision orbit 302 may intersect with the debris orbit 304 of the orbital debris 300. As shown in FIGS. 3B and 3C, the debris capture system 200 may translate toward and collide with the orbital debris 300. The debris capture system 200 may be oriented such that the impact structure 204 faces and collides with the orbital debris 300. The impact structure 204 may deform and receive the debris therein.

The impact structure 204 may retain the orbital debris 300 within the deformed impact structure 204. The impact structure 204 may deform and absorb the impact energy from the orbital debris 300. The orbital debris 300 may form an opening 310 in the impact structure 204, such as the sidewall 204A and/or the forward wall 204B. A depth 311 of the opening 310 formed by the orbital debris 300 may be based on a size 306 of the orbital debris 300 and/or a relative speed between the debris capture system 200 and the orbital debris 300 upon impact. The thickness 210 of the impact structure 204 may be sized to be greater than a theoretical maximum depth 311 of the opening 310 that would be formed by the orbital debris 300 at a maximum relative impact speed and maximum size of debris. In some embodiments, the impact structure 204 may be configured to capture orbital debris 300 with a size 306 (e.g. maximum width) of 10 cm or less, 9 cm or less, 7 cm or less, 6 cm or less, 5 cm or less, 4 cm or less, 3 cm or less, 2 cm or less, or 1 cm or less. The impact structure 204 may have a maximum dimension 210A, where the theoretical maximum depth 311 is no more than 50%, no more than 75%, or no more than 90% of the maximum dimension 210A.

The thickness may thus be based on an anticipated mass/velocity distribution of debris particles to be intercepted on orbit, and when the impact structure is also a primary structural element, by the requirements of said structure. Beyond a minimum structural/functional requirement, additional metal foam composite/impact structure material may be added to tailor performance to the conditions on orbit.

In some embodiments, the impact structure 204 may be configured to capture a predetermined number of particles of orbital debris 300. In some embodiments, the impact structure 204 may be configured to capture up to 20 particles of orbital debris 300, up to 40 particles of orbital debris 300, up to 50 particles of orbital debris 300, up to 100 particles of orbital debris 300, up to 200 particles of orbital debris 300, up to 500 particles of orbital debris 300, up to 1000 particles of orbital debris 300, and/or any value between the aforementioned values. The predetermined number of orbital debris particles may be based on at least the size 306 of the orbital debris 300, the speed of the orbital debris 300, the speed of the debris capture system 200, the relative speed between the debris capture system 200 and the orbital debris 300, and/or the thickness 210 of the impact structure 204.

The orbital debris 300 may reduce a speed of the debris capture system 200 when the orbital debris 300 collides with the debris capture system 200. Accordingly, the orbital debris 300 may cause the speed of the debris capture system 200 to decay until the debris capture system 200 deorbits.

FIG. 4 illustrates an embodiment of the debris capture system 200 with a flight control system 400. The flight control system 400 may be positioned in the cavity 208 of the debris capture system 200. In some embodiments, the flight control system 400 may include control system 402, one or more power supplies 404, and/or one or more thruster packs 406. The one or more power supplies 404 may be configured to provide power to the control system 402 and/or thruster packs 406. The one or more power supply 404 may include one or more batteries, one or more solar panels, and/or any other power supply.

In some embodiments, each thruster pack 406 may include one or more propellant tanks 406A configured to eject gas from one or more nozzles 406B. As shown, each thruster pack 406 includes a dedicated propellant tank 406A in fluid communication with multiple nozzles 406B. There may be more than one or more propellant tanks 406A and/or one or more nozzles 406B for each thruster pack 406. In some embodiments, the propellant tanks 406A may include a composite overwrap. In some embodiments, the thruster packs 406 may include cold-gas thruster packs where the propellant tanks 406A are dedicated composite-overwrapped pressure vessels. In some embodiments, the propellant tanks 406A may be configured to store fuel and/or oxidizer. The thruster packs 406 may be configured to position the debris capture system 200 in an orbit, such as the debris collision orbit 302. The thruster packs 406 may modify an attitude of the debris capture system 200 and/or maneuver the debris capture system 200 in order to position the debris capture system 200 in the desired orbit. In some embodiments, the thruster packs 406 may be configured to deorbit the debris capture system 200 after the debris capture system 200 captures orbital debris.

FIGS. 5A-5C illustrate side cross-sectional views of other embodiments of debris capture systems 500A, 500B, 500C. The debris capture systems 500A, 500B, 500C may include any of the features of the debris capture system 200, and vice versa. As shown in FIG. 5A, the debris capture system 500A may include a rectangular cross-sectional profile, to form a cube or box three-dimensional shape. As shown in FIG. 5B, the debris capture system 500B may include a triangular cross-sectional profile, to form a conical three-dimensional shape. As shown in FIG. 5C, the debris capture system 500C may include a semi-circular profile shape, to form a semi-spherical three-dimensional shape.

FIGS. 6A-6D illustrate top views of other embodiments of debris capture systems 600A, 600B, 600C, 600D viewed from a forward end. The debris capture systems 600A, 600B, 600C, 600D may include any of the features of the debris capture systems 200, 500A, 500B, 500C, and vice versa.

As shown in FIG. 6A, the debris capture system 600A may include a square or rectangular planform. As shown in FIG. 6B, the debris capture system 600B may include an ovular or elliptical planform when viewed from a forward end of the debris capture system 600B. As shown in FIG. 6C, the debris capture system 600C may include a polygonal planform, such as the hexagonal planform as shown. As shown in FIG. 6D, the debris capture system 600D may include a triangular shape. The various shapes may include the impact structure having a forward wall and a sidewall, as described herein. The sidewall may be sloped as described, or it may be perpendicular to a base of the respective debris capture system.

FIG. 7 illustrates a schematic of an embodiment of a debris capture system 700. debris capture system 700The debris capture system 700 may include the control system 402, the power supply 404, the thruster packs 406, and/or the release systems 114, 116, 117. In some embodiments, the control system 402 may include a communication module 702, a controller 704, one or more processors 706, one or more memories 708, a mass storage device 710, and/or one or more modules 712. The communication module 702 may be configured to send and/or receive signals from other components of a rocket, such as the first stage 102 or the second stage 104. The communication module 702 may be configured to send and/or receive signals from a control station.

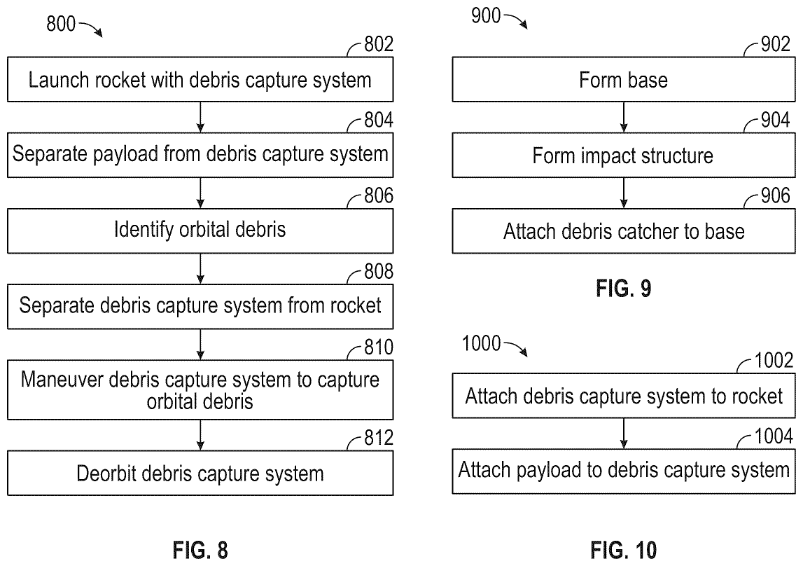

The one or more memories 708 and/or the one or more modules 712 may include instructions stored thereon. The one or more memories 708 and/or the one or more modules 712 may be located in the debris capture system and/or remotely located, such as on another spacecraft or ground station(s). The one or more processors 706 may execute the instructions to perform various methods. The method may include any of the methods described herein, for example any method described with respect to FIGS. 8-10. The performed method may include any or all of the following steps: releasing a payload from the orbital debris capture system; releasing the orbital debris capture system from a rocket; inserting the orbital debris capture system into a debris collision orbit; impacting the orbital debris with the impact structure; deorbiting the orbital debris capture system; firing thrusters of the orbital debris capture system; and/or adjusting an attitude of the orbital debris capture system.

The controller 704 may be configured to transmit instructions to the release systems 114, 116, 117, and/or the thruster packs 406. In some embodiments, the controller 704 may be configured to generate instructions based on one or more signals received from the communication module 702. In some embodiments, the controller 704 may be configured to generate instructions based on launch instructions stored on the controller 704.

The one or more other modules 712 may include instructions to carry out any other functions, methods, acts, and/or processes described herein. The instructions of the one or more modules 712 may be executed by the one or more processors 706 as discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by the one or more processors, such as central processing unit (PU) or other computing systems, and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted. A non-transitory computer readable medium, such as a hard drive, disk, or other system, may store the various instructions thereon.

The control system 402 may include the one or more processors 706, which may comprise a microprocessor. The control system 402 may further include one or more memories 708, such as random-access memory (RAM) for temporary storage of information, a read only memory (ROM) for permanent storage of information, and/or a mass storage device 710, such as a backing store, hard drive, rotating magnetic disks, solid state disks (SSD), flash memory, phase-change memory (PCM), 3D XPoint memory, diskette, or optical media storage device. Alternatively, the mass storage device 710 may be implemented in an array of servers. The components of the control system 402 may be connected using a standards-based bus system. The bus system may be implemented using various protocols, such as Peripheral Component Interconnect (PCI), Micro Channel, SCSI, Industrial Standard Architecture (ISA) and Extended ISA (EISA) architectures.

In some embodiments, the control system 402 may comprise a physical or logical connection established between one or more remote processors and a mainframe host computer for the express purpose of uploading, downloading, or viewing interactive data and databases on-line in real time. The remote processor may be operated by an entity operating the control system 402, including a client server system or a main server system, and/or may be operated by one or more data sources and/or one or more computing systems. In some embodiments, terminal emulation software may be used on the processor for participating in the micro-mainframe link.

FIG. 8 illustrates a flow chart showing an embodiment of a method 800 for capturing orbital debris that may be used with or performed by any of the debris capture systems of FIGS. 1A-6D. The method 800 may be used with or performed by the debris capture systems 200, 500A, 500B, 500C, 600A, 600B, 600C 600D, 700.

In some embodiments, the method 800 begins at step 802 where a rocket with a debris capture system may be launched. The rocket may include a first stage, a second stage, a debris capture system, a payload, and/or a fairing. In some embodiments, the debris capture system may support the payload and/or the fairing during launch. In some embodiments, the rocket may be launched into a planned low earth orbit or an outer space orbit.

In some embodiments, the method 800 then moves to step 804, where the payload may be separated from the debris capture system. In some embodiments, the step 804 may include the second stage separating from the first stage prior to the payload separating from the debris capture system. In some embodiments, the step 804 may include the fairing separating from the debris capture system before the payload is separated from the debris capture system. In some embodiments, the step 804 may include the second stage reaching a desired orbit prior to releasing the payload. The payload may be separated from the debris capture system at step 804 by a controller (e.g., controller 704). The controller may instruct a release system (e.g., release system 114, 116, 117) to release the payload from the debris capture system.

In some embodiments, the method 800 next moves to step 806, where orbital debris may be identified. Debris orbital parameters may be identified remotely via ground-based or space-based assets prior to launch, remotely on orbit via optical means (e.g., direct imaging, LIDAR, occlusion imaging,) active or passive RF (radar), or directly on orbit via impact monitoring (e.g., foil break sensors, wire break sensors, piezoelectric impact transducers, etc.)

In some embodiments, the orbital debris may be identified before the rocket is launched at step 802 or while the rocket is in flight. In some embodiments, a position and/or the orbit of the orbital debris may be identified. In some embodiments, the second stage and/or the debris capture system may include one or more sensors configured to detect the position and/or the orbit of the orbital debris.

In some embodiments, the method 800 next moves to step 808, where the debris capture system is separated from the second stage. The debris capture system may be separated from the second stage rocket body after the payload and fairing are separated from the second stage. The debris capture system may be separated from the second stage rocket body at step 804 by the controller (e.g., controller 704). The controller may instruct a release system (e.g., release system 114, 116, 117) to release the debris capture system from the second stage rocket body. The second stage may be maneuvered and/or positioned based on the position and/or the orbit of the orbital debris to assist the debris capture system with targeting the debris. The second stage may be maneuvered and/or oriented so the debris capture system is positioned in or near the orbit of the orbital debris when the debris capture system separates from the second stage. In some embodiments, the second stage may be maneuvered and/or oriented so the debris capture system is positioned in a second orbit that intersects with the orbit of the orbital debris. The controller (e.g., controller 704) may be configured to maneuver and/or orient the debris capture system. The controller may instruct thrusters (e.g., thruster packs 406) to fire in order to maneuver and/or orient the debris capture system.

In some embodiments, the method 800 next moves to step 810, where the debris capture system may be maneuvered and/or oriented to capture orbital debris. A flight control system (e.g., the debris capture system 700) of the debris capture system may be configured to maneuver and/or orient the orbital debris in the second orbit that intersects with the orbit of the orbital debris. The controller (e.g., controller 704) may be configured to instruct thrusters (e.g., thrusters 406) to fire in order to maneuver and/or orient the debris capture system in the second orbit. The flight control system may be configured to maneuver and/or orient the debris capture system so the orbital debris collides with the impact structure of the debris capture system. Thus, in step 810 the debris capture system may impact and retain the debris. In some embodiments, prior to separation of the debris capture system, the second stage may be maneuvered and/or oriented to cause debris to impact the debris capture system while the debris capture system is coupled with the second stage.

In some embodiments, the method moves to step 812, where the debris capture system may deorbit. In some embodiments, the orbital debris may reduce a speed of the debris capture system when the orbital debris collides with the debris capture system. Accordingly, as the speed of the payload decreases, the second orbit of the debris capture system may decay until the debris capture system deorbits. In some embodiments, the debris capture system may be positioned in low earth orbit. Accordingly, the second orbit of the debris capture system may naturally decay until the debris capture system deorbits. In some embodiments, the flight control system of the debris capture system may be configured to deorbit the debris capture system. The orbital debris capture system may have thrusters (e.g., thrusters 406) pointed in a forward direction, or the system may turn around and fire the thrusters in a forward direction to slow the speed. The controller (e.g., controller 704) may be configured to instruct the thrusters (e.g., thrusters 406) to fire in order to slow the speed of the orbital debris capture system. When the payload deorbits, any orbital debris captured by the debris capture system at step 810 may be retained in the impact structure. Accordingly, the orbital debris may be removed from orbit and/or outer space.

FIG. 9 illustrates a flow chart showing an embodiment of a method 900 of manufacturing a debris capture system that may be used to make any of the debris capture systems of FIGS. 1A-7. In some embodiments, the method begins with step 902, where a base of the debris capture system may be formed. The base may be a composite formed in a mold, or a metallic structure formed by machining, or other suitable methods.

In some embodiments, the method 900 then moves to step 904, where an impact structure of the debris capture system may be formed. A metal foam composite comprising a metal foam and metallic layers may be manufactured and assembled together. A metal foam may be manufactured having pores or voids therein. Sheet metal may be formed and machined to form the outer layers of the impact structure. The layers may be assembled on opposing sides of the metal foam to form the sandwich composite shape.

In some embodiments, in step 902 and/or 904, one or more release devices and/or one or more flight control system components may be assembled with the debris capture system.

In some embodiments, the method 900 next moves to step 906, where the impact structure may be attached to the base to form the debris capture system. The impact structure may be attached via one or more of the following: bolted joint via studs molded into the metal foam composite material; bolted joints via captive nuts or inserts in the metal foam composite material; integral casting of the metal foam composite material and the payload interface; over-molding; hot isostatic pressing; interference fit; sintering; brazing; explosive welding of dissimilar metals; ultrasonic welding; electron beam welding; friction stir welding; and independent attachment of the metal foam composite and payload interface to a common structural member or assembly. In some embodiments, in step 906 one or more of the release devices may be attached to the debris capture system.

FIG. 10 illustrates a flow chart showing an embodiment of a method 1000 of assembling a debris capture system with a rocket and a payload. The method 1000 may be used with any of the debris capture systems of FIGS. 1A-7.

In some embodiments, the method begins with step 1002, where a debris capture system may be attached to the rocket, such as a second stage rocket. The debris capture system may include a base and an impact structure. The base of the debris capture system may be attached to the rocket. The debris capture system may be attached to a forward end of a second stage of the rocket. The debris capture system may be attached to a rocket with one or more release devices configured to separate the debris capture system from the rocket.

In some embodiments, the method 1000 then moves to step 1004, where a payload may be attached to the debris capture system. The payload may be attached to the impact structure and/or the release devices of the debris capture system. Accordingly, the debris capture system may support the payload throughout a launch mission. In some embodiments, the debris capture system may serve a dual purpose as a payload adaptor to support the payload thereon. The payload adaptor may be welded, e.g. friction welded, to the impact structure or base. In some embodiments, the payload adaptor may be coupled to one or more release devices in order to attach the payload adaptor to the debris capture system.

In some embodiments, step 1004 may be performed prior to step 1002. Thus the payload may be attached to the debris capture system, which may then be attached to the rocket. In some embodiments, the step 1004 may include positioning a fairing over the payload and the debris capture system. The fairing may be coupled to the second stage rocket or to the debris capture system.

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described as such. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

1. A rocket system comprising:
a rocket;
a payload; and
a debris capture system releasably coupled between the rocket and the payload, the debris capture system comprising:
a base; and
an impact structure coupled to the base, the impact structure comprising a metal foam composite configured to receive and retain therein orbital debris, wherein the debris capture system is configured to be released from the rocket after the payload is released from the debris capture system.

2. The system of claim 1, wherein the metal foam composite comprises an open-cell metal foam sandwiched between metallic layers.

3. The system of claim 1, wherein the debris capture system comprises a payload adaptor supporting the payload.

4. The system of claim 1 further comprising at least one release device that releasably couples the debris capture system with the rocket.

5. The system of claim 1 further comprising at least one release device that releasably couples the payload with the debris capture system.

6. The system of claim 1, wherein the debris capture system comprises one or more thrusters.

7. The system of claim 1, wherein the debris capture system comprises a flight control system.

8. An orbital debris capture system comprising:
an impact structure configured to deform upon impact with orbital debris thereby retaining the orbital debris after impact;
a first release system configured to releasably couple the orbital debris capture system with a payload;
a second release system configured to releasably couple the orbital debris capture system with a rocket; and
a flight control system configured to insert the orbital debris capture system into a debris collision orbit after release from the rocket.

9. The system of claim 8, wherein the impact structure comprises a metal foam composite.

10. The system of claim 9, wherein the metal foam composite comprises an open-cell metal foam sandwiched between metallic layers.

11. The system of claim 8, wherein the orbital debris capture system further comprises a payload adaptor supporting the payload.

12. The system of claim 8, wherein the orbital debris capture system further comprises one or more thrusters.

13. The system of claim 8, wherein the impact structure comprises a sloped sidewall.

14. The system of claim 8, wherein the impact structure is configured to capture orbital debris with a maximum width of 2 cm or less.

15. An orbital debris capture system comprising:
an impact structure configured to deform upon impact with orbital debris thereby retaining the orbital debris after impact; and
a control system comprising:
one or more processors; and
one or more memories having instructions stored thereon that, when executed by the one or more processors, causes the orbital debris capture system to perform a method of capturing orbital debris, the method comprising:
releasing a payload from the orbital debris capture system;
releasing the orbital debris capture system from a rocket; and
inserting the orbital debris capture system into a debris collision orbit.

16. The system of claim 15, wherein the method further comprises impacting the orbital debris with the impact structure.

17. The system of claim 15, wherein the method further comprises deorbiting the orbital debris capture system.

18. The system of claim 15, wherein the method further comprises firing thrusters of the orbital debris capture system.

19. The system of claim 15, wherein the method further comprises adjusting an attitude of the orbital debris capture system.

20. The system of claim 15, wherein the impact structure comprises a metal foam composite.
